(19) United States
(12) Patent Application Publication
(10) Pub. No.: US 2012/0085710 A1
(43) Pub. Date: Apr. 12, 2012

(54) METHOD AND APPARATUS FOR PROVIDING AND USING HYDROGEN-BASED METHANOL FOR DENITRIFICATION PURPOSES

(75) Inventor: Roland Meyer-Pittroff, Freising (DE)

(73) Assignee: Silicon Fire AG, Meggen (CH)

(21) Appl. No.: 13/252,979

(22) Filed: Oct. 4, 2011

(30) Foreign Application Priority Data
Oct. 6, 2010 (EP) PCT/EP2010/064948
Feb. 1, 2011 (EP) EP11152947.5
Feb. 22, 2011 (EP) EP11155310.3
May 26, 2011 (EP) EP11167622.7

(51) Int. Cl. C02F 1/68; C02F 101/16

(52) U.S. Cl. 210/750; 210/192

(57) ABSTRACT

A green process for denitrification using a methanol-containing liquid generated by a catalytic reaction of a starting material formed by mixing carbon dioxide gas with hydrogen gas. This process can advantageously be used for denitrification in waste water treatment plants and, if the hydrogen is generated from water and/or methane derived from the waste water, the process can be self-contained and conducted completely at the waste water treatment plant.

### CROSS-REFERENCES TO RELATED APPLICATIONS

The present application claims the priorities of European Patent Application No. 11167622.7, filed May 26, 2011; European Patent Application No. 11155310.3, filed Feb. 22, 2011; European Patent Application No. 11152947.5, filed Feb. 1, 2011; and Patent Cooperation Treaty Application No. PCT/EP2010/064948, filed on Oct. 6, 2010; all of which are incorporated herein by reference in their entirety for all purposes.

### FIELD OF THE INVENTION

The present application relates to a method and an apparatus for providing and using hydrogen-based methanol for denitrification purposes.

### BACKGROUND OF THE INVENTION

Carbon dioxide CO2 is a chemical compound comprising carbon and oxygen. Carbon dioxide is a colorless and odorless gas. At a low concentration, it is a natural component of air and occurs in living beings during cell respiration, but also during the combustion of carbonaceous substances if sufficient oxygen is present. Since the beginning of industrialization, the CO2 component in the atmosphere has significantly risen. The main causes of this are the CO2 emissions caused by humans—so-called anthropogenic CO2 emissions. The carbon dioxide in the atmosphere absorbs a part of the thermal radiation. This property makes carbon dioxide a so-called greenhouse gas (GHG) and one of the contributing causes of the global greenhouse effect.

For these and other reasons, research and development is currently being performed in greatly varying directions in order to find a way to reduce the anthropogenic CO2 emissions. In particular in connection with power generation, which is frequently performed by the combustion of fossil fuels, such as coal, oil, or gas, but also with other combustion processes, for example, garbage burning, there is a great demand for reduction of the CO2 emission. Currently, approximately 30 billion tons of CO2 are discharged into the atmosphere per year by such processes.

It is considered to be a problem that CO2 arises during the combustion of fossil fuels. In addition, the fossil resources, which are finite, are irrevocably consumed. Research is being performed in greatly varying directions in order to reduce the consumption of vehicles or to develop vehicles which are driven completely using regenerative power.

In addition to the problems of air contamination and stress, there are also problems in connection with water contamination. Specifically, nitrogen occurs in water both molecularly as nitrogen (N2) and also in inorganic and organic compounds. Urea is the largest nitrogen source in municipal wastewater. The limiting value for drinking water is 50 mg/L of nitrate, which corresponds stoichiometrically to approximately 11 mg/L nitrate nitrogen, according to the locally applicable drinking water code.

It is known that the nitrogen component in the wastewater can be reduced by denitrification methods (also referred to as denitrification or nitrogen elimination). In denitrification, nitrates are reduced to form oxygen-poor nitrogen compounds and then to elementary, gaseous nitrogen. A biologically degradable organic substrate is required for denitrification. If sufficient substrate is not present, methanol is supplied, for example.

Methanol is a particularly advantageous substrate, since it is fully soluble in water and is easily biologically degradable. However, methanol has been produced up to this point from fossil raw materials, for example, from natural gas in most cases. Numerous methods and reactors for producing methanol are known. Exemplary patent applications and patents include:
EP 0 790 226 B1;
WO 2010/037441 A1;
EP 4 483 919 A2.

The demand exists for the provision of methanol which is CO2-neutral and cost-effective to produce. In addition, the methanol production should not compete with food production and should not require space, as in the production from biomass.

The object presents itself of developing a corresponding method and a corresponding apparatus for providing methanol especially for denitrification purposes in wastewater treatment plants, which is ecologically and economically advisable.

### SUMMARY OF THE INVENTION

Therefore, a novel method chain is proposed according to the invention, which relates to the provision and consumption of methanol in a wastewater treatment plant.

The method, in a preferred form, comprises the following steps:

providing a gas having a carbon dioxide component (CO2) as a carbon supplier,

providing a hydrogen component (H2),

mixing the carbon dioxide component and the hydrogen component to form a starting material,

introducing the starting material into a reactor,

passing the starting material through a section of the reactor which is at least partially equipped with a catalyst in order to synthesize methanol using a synthetic-catalytic method,

obtaining a liquid mixture made of a methanol component and a water component,

using the methanol containing liquid in a wastewater treatment plant for denitrification purposes.

The goal of the invention is also to provide a system which functions as autonomously as possible, i.e., as much as possible independently of the power grid. In particular, this relates to a method in which at least a part of the power requirement, which exists in order to provide the hydrogen component (H2) electrolytically, is generated locally in the wastewater treatment plant or in its immediate surroundings.

The power is preferably generated when waste materials which occur in a sewage plant are combusted in order to operate a power generator, or in that waste materials are converted into methane-containing gas, for example, and this gas is used for the power generation.

Alternatively, the hydrogen component (H2) can also be generated directly from methane-containing gas, for example. In this case, electrolysis is not necessary to provide the hydrogen component (H2).

A combination of an electrolysis plant and hydrogen provision from locally existing gas is also possible.

The invention is intentionally based on carbon dioxide and hydrogen as the starting materials, since the carbon dioxide is “recycled” in this way and can serve for the denitrification via the use of methanol as the carbon supplier.

Hydrogen can additionally or alternatively also be generated from regenerative energy and the carbon dioxide can be obtained from exhaust gases or generated from biomass, so that the methanol, which is synthesized from these starting materials catalytically, can be considered to be CO2-neutral. In addition, this way has the advantage that, upon the synthesis of methanol, for example, it provides a methanol-water mixture, which is directly suitable for denitrification. The composition of the methanol-water mixture is ideal to be used for denitrification, and it is distinguished in that it also has advantages from an environmental-technology aspect.

In contrast to previous methanol production methods, the product of the present methanol synthesis process, comprising methanol and water, can be used directly as the liquid for the denitrification. No further energy expenditure is required to distill the product of the synthesis process for denitrification. The energy expenditure for distilling, which is typically performed in order to obtain pure, highly-concentrated methanol, makes the methanol more costly.

According to the invention, synthesis gas which comprises H2 and CO2 is converted efficiently and in an economically advisable manner into methanol for denitrification purposes.

According to the invention, carbon dioxide is used as the starting carbon supplier for eventual denitrification. The carbon dioxide is caused to react with the hydrogen component in the presence of a catalyst, in order to convert it into a methanol-water mixture.

The carbon dioxide is preferably taken from a combustion process or an oxidation process of carbon or hydrocarbons by means of CO2 separation. For example, CO2 can originate from a sewage treatment process. If the CO2 originates from a sewage treatment process, the plant according to the invention is autonomous, since neither energy nor other materials must be externally delivered or supplied depending on the design of the plant and depending on the environmental conditions.

The method according to the invention for providing the denitrification liquid is controlled and the individual processes are “linked” to one another so that

the total yield and the quality of the methanol are ideal for the intended purpose,

and/or the (total) CO2 emission is as minimal as possible,

and/or the most consistent and long-term possible plant workload is achieved,

and/or the product-specific investment and operating costs are as minimal as possible.

Locally provided power and/or regenerative electrical power are preferably used to provide the methanol.

Using a corresponding plant, a methanol-water mixture is preferably produced as a liquid which can be stored and transported, i.e., the locally provided power and/or renewable power is chemically converted into a liquid which is relatively simple to store and transport.

The production of the liquid as a mixture which can be stored and transported relatively simply can be phased down or even interrupted at any time. The processing plant parts for producing the mixture can be phased down or shut down relatively easily and rapidly. The ultimate decision is in the scope of responsibility of the operator of the plant

Preferred embodiments of the invention are based on hydrogen generation with the aid of electrical energy, which is locally (i.e., on location in the area of the wastewater treatment plant) generated regeneratively as much as possible, and originates, for example, from biomass, biogas, fermentation gas, wind, water, geothermal, and/or solar power plants, for example. Hydrogen which is generated on location via electrolysis and/or from waste materials, for example, does not need to be stored or highly compressed or cryogenically liquefied and transported over long distances, but rather serves as an intermediate product, which is preferably supplied at the location of its generation immediately or soon to the above-mentioned reaction to generate methanol.

The corresponding methanol-water mixture can also be generated according to the invention employing an intelligent energy mix (as described, for example, in International Patent Application WO2010069622A1 of fossil and regenerative energy.

A novel method relevant to power engineering and a corresponding use are provided according to the invention in consideration of corresponding power engineering, industrial, and economic parameters, together with the requirement for careful use of all material, energetic, and economic resources.

Further advantageous embodiments can be inferred from the description, the figures, and the dependent claims.

Various aspects of the invention are schematically shown in the drawings.

### BRIEF DESCRIPTION OF THE DRAWINGS

FIG. 1 shows a schematic diagram, which indicates the basic steps of the preferred method;

FIG. 2 shows a schematic diagram which also indicates the basic steps of the preferred method according to the invention;

FIG. 3 shows a lateral external view of a reactor which can be used in a method according to the invention;

FIG. 4 shows a schematic view of an overall wastewater treatment method according to the invention;

FIG. 5 shows a schematic view of an overall method according to the invention for using the locally existing resources, in order to make the method autonomous.

### DETAILED DESCRIPTION OF THE INVENTION

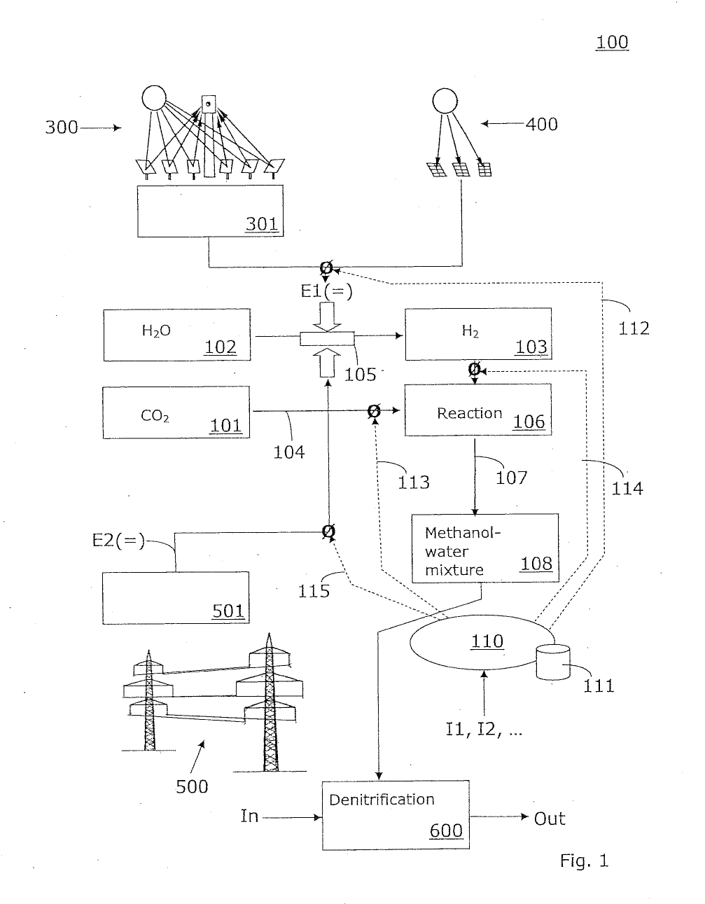

FIG. 1 shows methanol-water mixtures 108, which are also referred to as methanol-containing liquids.

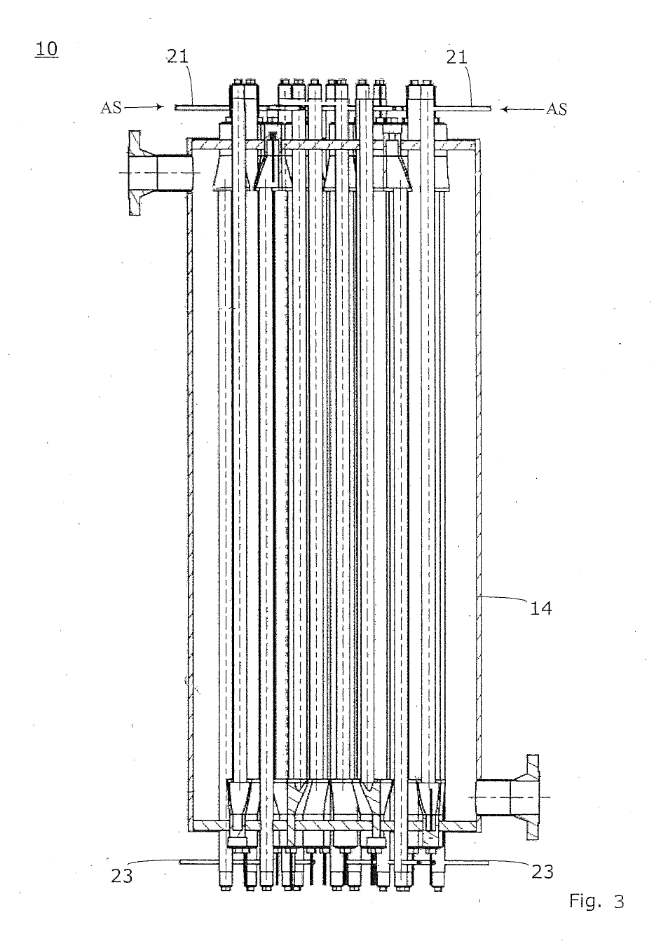

The term mixture 108 is used here, since the product which is provided at the outlet 23 of a reactor 10 (FIG. 3) does not consist of 100% methanol. Rather, it is a so-called physical mixture of methanol and water.

The term wastewater treatment plant is used here for any type of plant which is usable for (waste) water treatment or purification. In particular, this relates to the use in a sewage treatment plant.

This especially relates to a combination of methanol denitrification and the use of methanol-water mixtures 108, the required CO2 being obtained from the fermentation gas and/or from the combustion gas. The required electrical energy being generated from a block heating power plant 602 (FIG. 5) operated by fermentation gas (combination of combustion engine with generator and waste heat usage, e.g., for heating the sewage treatment basins).

FIG. 1 shows a schematic block diagram of the most important building blocks/components, or method steps, of a preferred plant 100 according to the invention. This plant 100 is designed so that a method for providing the methanol liquid mixture 108 can be executed. The corresponding method is based on the following basic steps.

Carbon dioxide 101 is provided as the carbon supplier. The electrical DC energy E1 required for generating hydrogen 103 is generated here as much as possible by means of renewable energy technology and provided to the plant 100. Solar thermal plants 300, 301 and photovoltaic plants 400, which are based on solar modules, are particularly suitable as the renewable energy technology. For example, water power, wind power, or geothermal energy can also be used as regenerative energy sources. The regenerative energy sources can also be of biogenic origin (inter alia, sewage sludge or sewage gas), for example, or methane from other sources.

According to FIG. 1, a water electrolysis 105 is performed employing the electrical DC energy E1, in order to generate hydrogen 103 as intermediate product.

In the plant 100, an economically and ecologically optimum combination of regenerative power supply (e.g., by the sources 300 and/or 400) and conventional power supply, represented here by a part of an integrated network 500, is preferably implemented. A part or all of the electrical energy can also be locally generated (e.g., by using a locally occurring gas or locally occurring materials which may be converted). This plant 100 therefore provides using the electrical energy E1 substantially directly in accordance with its occurrence for chemical reactions (the electrolysis reaction 105 here) and therefore chemically binding and storing it. A further component of the required energy is acquired here, for example, from the integrated network 500 and/or from local plants (e.g., a generator). This component is converted into direct current (energy) E2. For this purpose, a corresponding converter 501 is used, as schematically indicated in FIG. 1. The corresponding plant parts or components are also referred to here as (local) power supply plant 501.

The power supply of the plant 100 according to FIG. 1 is controlled and regulated by means of an intelligent plant controller 110. Fundamentally, the instantaneously available excess energy share E2 is acquired from the integrated network 500, while the other energy share (E1 here) is acquired as much as possible from a (plant-related) solar power plant 300 and/or 400 (and/or from a wind power plant and/or from a biomass power plant and/or from a water power plant and/or from a geothermal power plant). This principle allows the operator of a plant 100 to incorporate additional technical and economic parameters in the controller of the plant 100. These parameters are so-called input variables 11, 12, etc., which are incorporated in decisions by the controller 110. A part of the parameters can be predefined within the controller 110 in a parameter memory 111. Another part of the parameters can come from the outside. The method according to the invention can be guided by the controller 110 in the plant 100 so that the methanol liquid 108 which is provided at the outlet meets the desired requirements with respect to the mixing ratio and/or the CO2 neutrality.

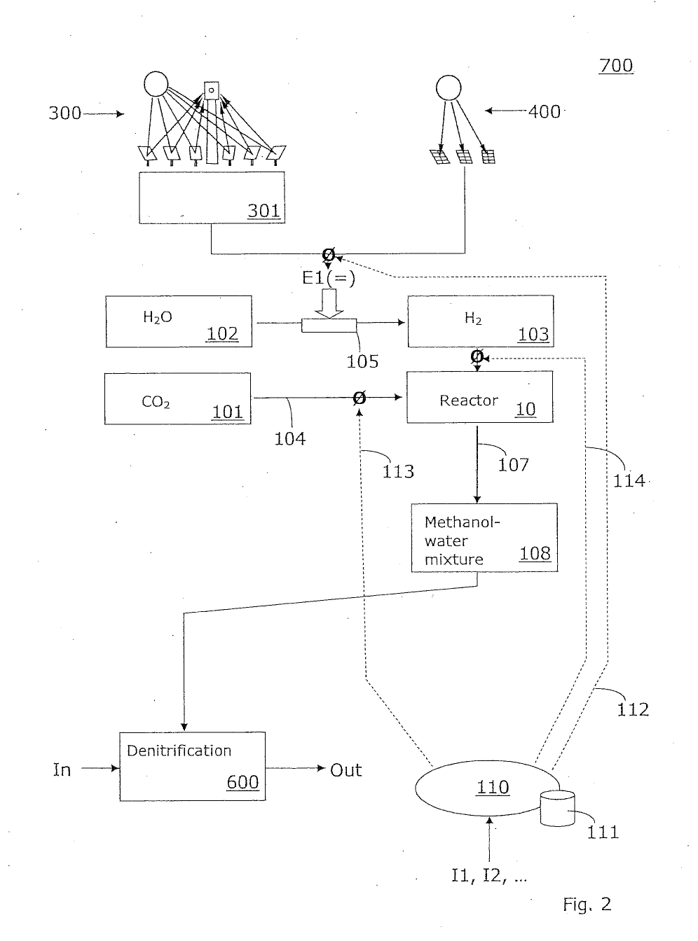

FIG. 2 schematically shows a further plant 700, which can be used in order to execute the method according to the invention. A part of this plant 700 corresponds to the plant 100 according to FIG. 1. Therefore, reference is made to the preceding description of the corresponding elements.

High-purity hydrogen 103, which is converted here into a methanol-water mixture 108, is also generated in this plant 700, as described, by a water electrolysis 105. The energy for this purpose originates in this embodiment entirely or substantially (preferably more than 80%) from regenerative energy sources 300 and/or 400, or from other regenerative energy sources and/or from local energy sources.

An number of control or signal lines can be provided, as illustrated on the basis of the lines 112, 113, 114, and 115 shown as examples. These lines 112, 113, 114, and 115 control energy or mass flows of the plant 100 or 700.

FIGS. 1 and 2 show that the methanol-water mixture 108 is used for the denitrification 600. Water (e.g., wastewater) is supplied on the inlet side (identified by IN). After the execution of the denitrification 600, water, which now contains less nitrogen, is discharged on the outlet side (identified by OUT). Details of this denitrification method 600 are well known and are not described in detail here.

So-called software-based decision processes are implemented in the plant controller 110. A processor of the controller 110 executes control software and arrives at programmed decisions by consideration of parameters. These decisions are converted into switching or control commands, which cause the control/regulation of energy and mass flows via control or signal lines 112, 113, 114, 115, for example. The method can be guided in the plant 100 by the controller 110, so that the liquid 108 which is provided at the outlet meets the desired requirements with respect to the mixing ratio and/or the CO2 neutrality.

According to the invention, carbon dioxide 101 is used as a gaseous carbon supplier 104, as schematically indicated in FIG. 1 and FIG. 2. The carbon dioxide 101 is preferably taken from a combustion process or an oxidation process via CO2 separation (e.g., a Silicon Fire flue gas purification plant). However, the carbon dioxide 101 can also be provided from a sewage treatment plant. The carbon dioxide 101 can also come from other sources.

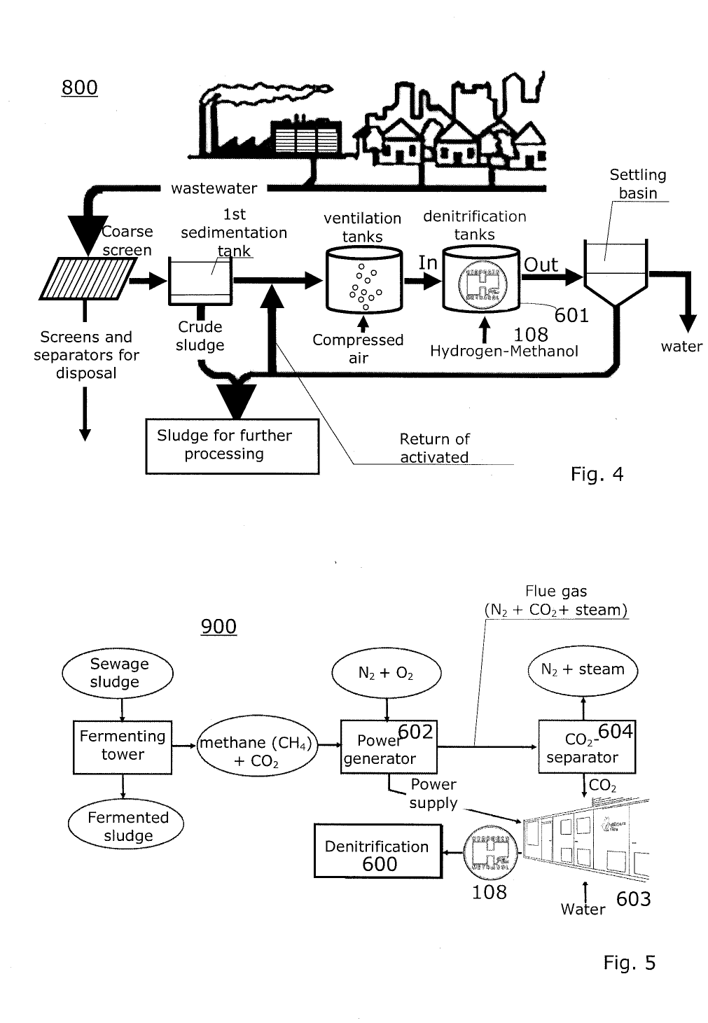

Furthermore, in the plant 700 shown in FIG. 2, electrical DC energy E1 is provided (this is also true for the plant in FIG. 4). The DC energy E1 is preferably locally generated substantially regeneratively (e.g., by one of the plants 300 and/or 400 and FIG. 2) and/or in another way. The DC energy E1 is used in the plant 700 shown to perform a water 102 electrolysis, in order to generate hydrogen 103 as an intermediate product. The electrolysis plant, or the performance of such an electrolysis, is identified in FIG. 1, FIG. 2, and FIG. 4 by the reference sign 105. The carbon dioxide 101 is mixed with the hydrogen 103 to form a starting material (AS). The starting material (AS) is then introduced into a reactor 10, as shown in FIG. 3, for example, in order to convert the gaseous (intermediate) products 101, 103 into the methanol-water mixture 108. The reaction 106 is performed in the reactor 10. The removal or the provision of the methanol-water mixture 108 is identified in FIG. 1 and FIG. 2 by the reference sign 107.

The mixing of the gases to form the starting material (AS) is critical, since the right stoichiometry has to be ensured. One might employ a gas mixer for mixing the gases. In addition, it is possible to employ one or two ring feed lines sitting on top of the reactor 10 so that equal quantities of gases to form the starting material are fed via a ring feed line(s) into the individual parallel reactor sections of the reactor. It is also possible to use a buffer space positioned in front of the individual reactor sections so that the starting material (AS) is fed into the buffer space from where it is then guided into each of the individual parallel reactor sections.

Water electrolysis employing direct current E1 is capable of generating hydrogen 103 as an intermediate product. The required hydrogen 103 is produced in an electrolysis plant 105 by the electrolysis of water H2O according to the following equation:

H2O−286.02 kJ=H2+0.5O2. (Reaction 1)

The required (electrical) energy E1 for this reaction of 286.02 kJ/mol corresponds to 143010 kJ per kg H2.

The synthesis of the methanol-water mixture 108 (CH3OH+H2O) can be performed in the reactor 10 of the plant 100 according to the exothermic reaction between carbon dioxide 101 (CO2) and hydrogen 103 (H2) as follows:

CO2+3H2=CH3OH+H2O−49.6 kJ (methanol-water mixture, gaseous) (Reaction 2)

The occurring reaction heat of 49.6 kJ/mol=1550 kJ per kg methanol=0.43 kWh per kg methanol 108 is dissipated from the corresponding reactor 10. For this purpose, the reactor 10 comprises a fluid chamber 14 (see FIG. 3, for example). The reactor 10 is preferably enclosed by a reactor mantle and is cooled by a fluid (preferably water).

Typical synthesis conditions in the synthesis reactor 10 are approximately 50 to 80 bar and approximately 270° C. The reaction heat can be “transferred” to other plant elements and used therein, for example.

The methanol-water synthesis is performed according to the invention employing a catalyst in order to keep reaction temperature, reaction pressure, and reaction time low in comparison to other methods and in order to ensure that a liquid methanol-water mixture 108, which is suitable as a denitrification liquid, results as the reaction product.

FIG. 2 indicates on the basis of the dashed arrow 112, which originates from the controller 110, that the controller 110 regulates the energy flow E1. The arrow 112 represents a control or signal line. Other possible control or signal lines 113, 114 are also shown. The control or signal line 113 regulates the CO2 quantity which is available for the reaction for example. For example, if less hydrogen 103 is produced, proportionally less CO2 must also be supplied. The optional control or signal line 114 can regulate the H2 quantity, for example. Such a regulation is advisable if there is a hydrogen buffer store from which a hydrogen 103 can be taken, even if no hydrogen or less hydrogen is currently being produced by electrolysis 105.

Details of a particularly preferred embodiment of a reactor 10 for synthesizing the methanol-water mixture 108 are shown in FIG. 3. The statements which are made on the synthesis of methanol mixture 108 in the International Patent Application PCT/EP2010/064948 may also be transferred to the synthesis of other liquid hydrocarbons.

The methanol-water mixture 108 is, as already described, synthesized employing a starting material (AS) which contains CO2 gas 101 and hydrogen gas 103. The corresponding reactor 10 comprises a reactor element or multiple reactor elements situated in parallel to one another. There is at least one gas intake 21 for the starting material (AS) on the reactor 10 and a product outlet 23, as shown as an example in FIG. 3.

The starting material (AS) is successively converted into a methanol-containing mixture 108 (referred to as alcoholic coolant liquid) as it passes through or is pressed through the reactor pipe(s) of the reactor 10. On the inlet side of the reactor 10, the methanol concentration of the reaction fluid is preferably zero and the concentration of the respective gaseous starting material (AS) is approximately 100%. In the direction of the outlet side of the reactor 10, the corresponding concentrations shift in opposite directions until a methanol-containing mixture 108 having a predefined methanol concentration (preferably a methanol-water mixture in the ratio 1:2) is formed at the product outlet 23.

The reactor 10 preferably delivers approximately 64 mass-% (69.2 vol.-%) methanol and 36 mass-% (30.8 vol.-%) water.

The reactor 10 or the elements of the reactor 10 preferably includes a catalyst for the synthesis of the methanol-water mixture 108 in all embodiments.

In all embodiments, a controller of the reactor 10 is preferably used, which initially applies hot fluid to the fluid chamber 14 at the beginning during the “startup” of the reactor 10, in order to get the synthesis reaction going. Subsequently, a cold fluid is preferably supplied, in order to dissipate reaction heat which arises during the exothermic synthesis and thus provide an isothermal environment.

The fluid chamber 14 is preferably designed in all embodiments so that at least the reaction sections of the reactor 10 which are filled with the catalyst are in the isothermal environment.

The reactor 10 is schematically shown in FIG. 3.

In all embodiments of the invention, the starting material (AS) is preferably introduced preheated and/or at elevated pressure through supply lines into the reactor 10. The pressure and the temperature are dependent on the type of the catalyst. The temperature is preferably in the range between 100 and 350° C. The pressure is typically between 10 and 150 bar. Therefore, it can also be stated that the starting material (AS) is preferably pressed through the reactor 10 with specification of an intake-side pressure between 10 and 150 bar in all embodiments.

The reactor 10 is especially suitable for the synthesis of a regenerative methanol-water mixture 108 made of carbon dioxide CO2 and hydrogen H2, which is generated via the (endothermic) electrolysis of water using regenerative electrical energy E1 according to reaction 1, as already mentioned above.

H2O−286.02 kJ/mol=H2+0.5O2 (Reaction 1)

The exothermic methanol-water synthesis (reaction 2, as already mentioned above) is represented by the summation formula:

CO2+3H2=CH3OH+H2O−49.6 kJ (gaseous methanol) (Reaction 2)

It must be emphasized that other synthesis methods and other reactors 10 or plants can also be used in all embodiments, of course, and the synthesis can be operated using regenerative energy and/or using regenerative starting material (AS). The use of regenerative energy and regenerative starting materials (AS) is preferred.

The use of the invention in connection with a method for methanol-water synthesis, which operates at low pressures between 10 and 150 bar (preferably at approximately 80 bar) is particularly advantageous.

The principle of the invention may also be transferred to large-scale plants, but is particularly suitable for autonomous local plants for wastewater treatment.

According to the invention, CO2 101 is used as the starting material and carbon supplier for the methanol-water synthesis in the reactor 10. Steam reforming plants, fermentation plants, and firing plants are preferably used as the CO2 sources.

Depending on the synthesis reaction, copper-based catalysts (e.g., CuO catalysts) or zinc oxide catalysts (e.g., ZnO catalysts) or chromium oxide-zinc oxide catalysts may be used, for example. Other known catalysts are also suitable for use in a reactor 10. Packed bed catalysts or fluid bed catalysts are particularly suitable. The catalyst can also comprise a suitable carrier (e.g., carbon, silicate, aluminum (e.g., Al2O3) or ceramic). Instead of the mentioned “metal” catalysts, an organic catalyst can also be used

In all embodiments, the catalysts preferably has a grain, bead, or particle size between 1 and 10 mm. A grain, bead, or particle size between 3 and 8 mm is particularly preferred.

Further fundamental details of the method according to the invention and the corresponding plants 100, 700, 800, 900 are described hereafter with reference to FIGS. 4 and 5. A schematic diagram of a complete plant 800 is shown in FIG. 4. The methanol mixture 108 is used in a denitrification tank 601 here. The process 600 occurs in the denitrification tank 601.

FIG. 5 shows the principle of the fermentation gas power generation and methanol production 900 according to the invention. The Silicon Fire mobile station 603 shown generates the methanol 108, which is used in step 600 for denitrification. A local power generator 602 (preferably a power generator 602 of a fermentation gas power generation plant) preferably delivers electrical power (power supply) to the Silicon Fire mobile station 603. A CO2 separator 604 delivers the CO2 for the methanol synthesis in the Silicon Fire mobile station 603.

In order to remove the nitrogen from the wastewater, a denitrification employing methanol 108 as a reducing agent is preferably executed in all embodiments as the last treatment step.

The reducing agent (methanol 108 here) is to be a degradable organic substance, which can be digested by bacteria and which allows the growth of new bacteria. The methanol 108 ideally meets these specifications, since it should not contain any toxic contaminants, in contrast to methanol produced from fossil fuel.

Theoretically, 1.9 kg methanol 108 is necessary to remove 1 kg nitrogen from the wastewater. In reality, approximately 2.5 kg methanol 108 is preferably used per kilogram of nitrogen.

In all embodiments, separate power generation is preferably used, which is ensured, for example, by a combustion plant-generator system operated by fermentation gas (see FIG. 5).

In addition to ecological advantages, sustained cost advantages also result through the invention.

What is claimed is:

1. A method for providing and using a methanol-containing liquid having the following steps:
providing a carbon dioxide gas as a carbon supplier,
providing a hydrogen gas,
mixing the carbon dioxide gas with the hydrogen gas to form a starting material,
introducing the starting material into a reactor through a section which is at least partially equipped with a catalyst in order to synthesize a methanol-containing liquid,
obtaining a liquid mixture made of methanol and water,
using the methanol-containing liquid in a denitrification process.

2. The method according to claim 1, wherein a power generator is supplied for the reaction of carbon dioxide gas with hydrogen gas.

3. The method according to claim 2, wherein the power is used in the reactor to generate the methanol-containing liquid.

4. The method according to claim 2, wherein the carbon dioxide gas is separated prior to supplying the carbon dioxide gas to the reactor.

5. The method according to claim 1, wherein waste heat of the reactor is used to support another process in a sewage treatment plant.

6. The method according to claim 2, wherein it is executed autonomously of an external power grid.

7. An apparatus which is designed to execute the method according to claim 6.

8. A sewage treatment plant having a fermentation gas power generation plant and having an apparatus according to claim 7 for methanol production.

9. The sewage treatment plant according to claim 8, wherein:
a local power generator is used as part of the fermentation gas power generation plant in order to deliver electrical energy for methanol production,
a CO2 separator is used, which delivers the carbon dioxide gas for the methanol synthesis in the reactor.

10. The sewage treatment plant according to claim 9, wherein the CO2 separator is connectable to the power generator so that CO2-containing flue gas can be transferred from the power generator to the CO2 separator.
